(19) United States
(12) Patent Application Publication
(10) Pub. No.: US 2013/0036461 A1
(43) Pub. Date: Feb. 7, 2013

(54) IMAGE-BASED AUTHENTICATION

(71) Applicant: T. Ethan Lowry, Santa Clara, CA (US)

(72) Inventor: T. Ethan Lowry, Santa Clara, CA (US)

(73) Assignee: APPLE INC., Cupertino, CA (US)

(21) Appl. No.: 13/195,765

(22) Filed: Aug. 1, 2011

(51) Int. Cl. G06F 21/00; G06F 7/04

(52) U.S. Cl. 726/19

(57) ABSTRACT

Techniques for authenticating a user of a computing device (e.g., handheld, desktop, laptop) are provided. In order to grant access to any of the services provided by the computing device, the computing device displays, to the user, one or more images that are stored on the computing device. The user is required to accurately identify one or more objects depicted in the one or more images in order to gain access to the computing device. The computing device is not required to be connected to any network at the time of authentication. Authentication data that is associated with object(s) in each displayed image may have been established previously by another computing device and then provided to the computing device.

### FIELD OF THE INVENTION

The present invention relates to authenticating a user of a computing device by displaying one or more images to the user and receiving input that identifies object(s) depicted in the one or more images.

### BACKGROUND

Handheld devices, such as tablet computers, laptops, and smart phones, have become ubiquitous. Users sometimes misplace their handheld devices or inadvertently leave them in public places. Such misplaced devices are easy prey for thieves. To dissuade thieves from stealing handheld devices (or people from accessing their friends' devices), many software manufacturers require a user to provide input that “unlocks” the handheld device. Such input may be a passcode of four or more characters. Without the required input, the user is not able to access data (e.g., work-related data, personal photos, etc.) stored on the handheld device or any services (e.g., a phone service) provided by the handheld device.

However, this approach for authenticating a user can be easily compromised. For example, a thief sitting on a bus may notice the four characters that an unsuspecting person entered on the person's smart phone. As another example, a thief may pick up a tablet computer in a public place and discover, based on finger prints on the display of the tablet computer, which characters were recently selected by the owner of the tablet computer. As another example, a person sees a friend enter a password into the friend's laptop. Later, the person accesses the laptop and views all the web pages that the friend has visited in the last day.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram that depicts a process for authenticating a user to a computing device, according to an embodiment of the invention;

FIG. 2 is a block diagram that depicts a set of names that are displayed concurrently with an image on a computing device, according to an embodiment of the invention;

FIG. 3 is a flow diagram that depicts a process for using different types of authentication, according to an embodiment of the invention;

FIG. 4 is a block diagram that illustrates a computer system 400 upon which an embodiment of the invention may be implemented.

### DETAILED DESCRIPTION OF EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Techniques are provided for authenticating a user to allow the user to have access to a computing device, such as a handheld device. In one embodiment, the process of authenticating involves (1) selecting at least one image that depicts one or more objects with which the user should be familiar, where the image is stored persistently on the computing device, and (2) displaying the image. An object may be a person's face, for example. Each image displayed by the computing device is associated with data that identifies (or is at least associated with) an object depicted in the image. The computing device then accepts input from the user. If the user input matches data that is associated with the object (e.g., where the input accurately identifies the object), then the user is allowed access to the computing device.

In a related technique, the computing device displays a series of two or more images. If the user properly identifies the object depicted in each displayed image, then the user is granted access to the computing device.

As used herein, a user has “access to a computing device” if the user is able to view data (other than data used to authenticate the user) that is stored on the computing device and/or to use services provided by the computing device. Thus, simply because person A has physical possession of a computing device does not necessarily mean that person A has access to the computing device. Non-limiting examples of data that is stored on the computing device include digital photos, contact information, word processing documents, music files, and video files. Non-limiting examples of services that the computing device might provide include a social network service, a phone service, a texting (SMS) service, a web browsing service, a camera service, a navigation service, and a mobile banking service. Each service is embodied in an application that executes on the computing device and may interact with another service (over a network) that is provided by one or more devices that are remote to the computing device.

### EXAMPLE PROCESS

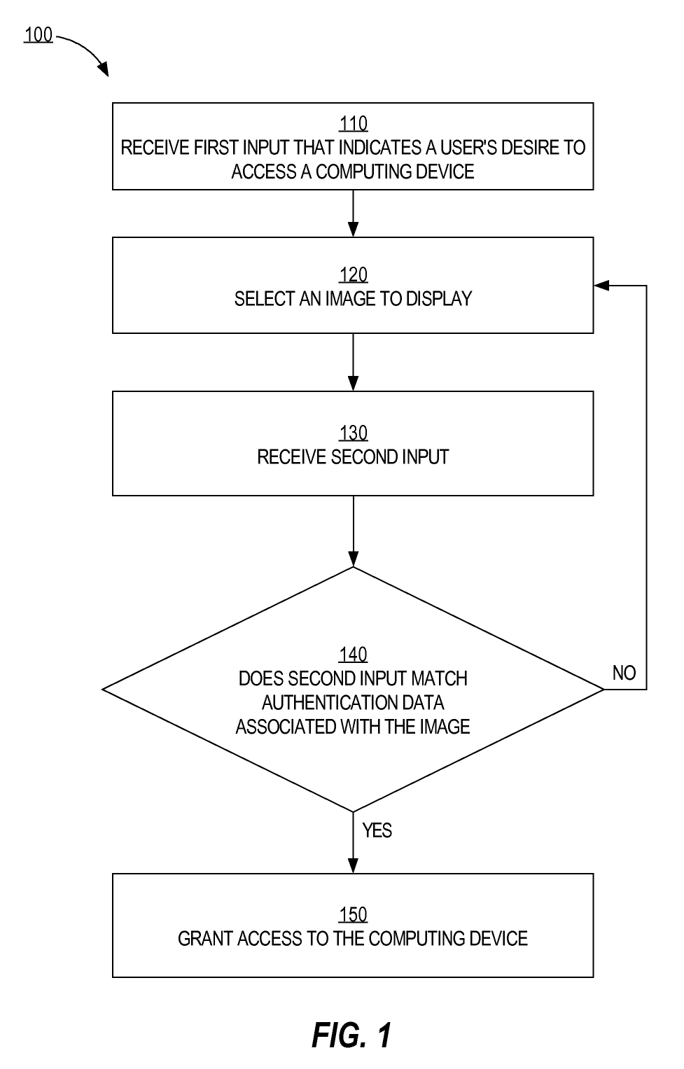

FIG. 1 is a flow diagram that depicts a process 100 for authenticating a user to a computing device, according to an embodiment of the invention. The computing device may be a handheld device, such as a laptop computer, a tablet computer, or a smart phone.

At step 110, the computing device receives first input that indicates the user's desire to access the computing device. The first input may be, for example, the press of a button on the computing device or the movement of a cursor control device that is connected to the computing device.

At step 120, an authenticating process executing on the computing device selects an image to display. The image depicts at least one object. The image is stored on the computing device at the time the first input is received. The object may be of any type, such as, for example, a person's face, an uncommon animal or insect, or a place of which only the user (or people in the user's circle of friends) might know. Also, the image may be stored in one of many types of formats.

At step 130, the computing device receives second input from the user. The second input may be based on text input or voice input. For example, after displaying an image that depicts a face of the user's sister Jane, the user may speak aloud, “Jane.” As another example, the user may type “Jane” on a physical keyboard of the computing device or on a graphical keyboard that is displayed on a touch screen of the computing device. Alternatively, step 120 might also include displaying, concurrently with the image or immediately after ceasing to display the image, a set of names. Then, as part of step 130, the user selects one of the displayed names that the user believes identifies the object.

At step 140, the authenticating process compares input data (associated with the second input) with authentication data that is associated with the object depicted in the image. The authenticating process determines whether the input data matches the authentication data. If so, then the process proceeds to step 150. If not, then the process proceeds to step 120. In addition to proceeding to step 120, the authenticating device may cause the computing device to display an indication that the second input was incorrect. If process 100 returns to step 120, then, in an embodiment, the user must enter the proper input for multiple images. In other words, steps 120-140 are performed again multiple times before proceeding to step 150.

At step 150, the authenticating process grants the user access to the computing device. Thus, the user is allowed to view and modify data stored on the computing device and/or use one or more services provided by the computing device.

### OBJECT IDENTIFICATION

An object that is depicted in an image (displayed as part of the authentication process) may be identified previously, either at the computing device to which access is sought or at another device. For example, the computing device includes a mechanism (i.e., software) that allows a user to provide data that identifies or describes an object and stores that data in association with an image that includes a depiction of the object. Such data may be considered “identification data” or “description data.” The mechanism may be a photo management application that executes on the computing device or is provided as a web service that is accessible over the Internet. The image may be stored persistently on the computing device or on a device (e.g., that is part of a cloud service) that is remote to the computing device.

As another example, an owner of the computing device may own a second computing device that executes a photo management application that has access to multiple images that are stored persistently at the second computing device or persistently by a cloud service. The photo management application detects at least one object (e.g., a person's face) that is depicted in a particular image. The photo management application may then prompt a user to identify or describe the object. The user then provides input (e.g., voice or text) that serves as an identifier of the object. The user may provide other input (e.g., tags) that describes the object, such as a nickname for the object, a date of when the object was created (if the object is man-made), a short description of the object, or a location associated with the object. The photo management application stores the identifier (and/or other input data) in association with the particular image and, optionally, with the object detected in the particular image. The particular image may depict multiple objects, each of which may be associated with an identifier and/or description. Thus, an image may be associated with multiple identifiers, one for each object depicted in the image.

In a related example, the photo management application (whether executing on the computing device or another computing device) may automatically identify an object depicted in a particular image. For example, a user may have confirmed the identity of the object depicted in one or more other images. Due to a high similarity score between the object depicted in the particular image and the objects depicted in each of the one or more other images, the photo management application automatically associates (without additional input from the user) an identifier of the object with the particular image or with the object depicted in the particular image. Alternatively, even with a high similarity score, the photo management application prompts the user to confirm that the object depicted in the particular image is what (or who) the photo management application determines the object to be.

If the photo management application resides on a second computing device that is different than the computing device that employs image-based authentication (i.e., the “target” computing device), then digital images that are/were accessible to the second computing device are sent to the target computing device. Before the target computing device receives the digital images, the digital images may have been stored by a cloud service that is remote to both computing devices.

Such identification data and/or description data may be used as authentication data when authenticating a user to a computing device. For example, the computing device displays an image that depicts an object. The user then provides input to the computing device, which then compares the corresponding input data to authentication data associated with the object. If the input data matches the authentication data, then the computing device grants access to the user.

### MULTIPLE ROUNDS AUTHENTICATION

Process 100 involves using a single image to authenticate a user. The process of causing a single image to be displayed and receiving input that purportedly identifies or describes an object in the single image is referred to herein as a “round.” Because FIG. 1 indicates that a user may be granted access after a single round, process 100 is considered a single round process.

However, in an embodiment, multiple images are displayed on a computing device, one at a time, as part of the authentication process. After each image is displayed, a user must provide the proper input that identifies (or describes) an object depicted in the image. If the user provides the correct input for each displayed image, then the user is granted access to the computing device. An authentication process that requires multiple rounds before a user is granted access to a computing device is referred to herein as a “multiple round process.”

If a multiple round process requires a particular number of correct answers or inputs, then any incorrect answers will extend the multiple round process at least by the same number of incorrect answers. For example, if a multiple round process is three rounds, then one incorrect answer will extend the authentication process by another round. As another example, if a multiple round process is two rounds, then two incorrect answers will extend the authentication process by at least two rounds. If a certain number of incorrect answers are provided (e.g., three), then the authentication process may not display any more images for a certain amount of time (e.g., 30 seconds).

In an embodiment, for each round, the computing device displays a set of identifiers. Each identifier in the set of identifiers may be, for example, a name, description, or year that is associated with an object depicted in the image. Thus, an identifier may be any sequence of (e.g., alphanumeric) characters. The set of identifiers may be displayed concurrently with an image or may be displayed immediately after the image ceases to be displayed. Or the set of identifiers may be displayed concurrently with an image for a period of time (e.g., 2 seconds), after which the image ceases to be displayed and the set of identifiers continue to be displayed.

An identifier may be selected using one or more keys on a physical keyboard of the computing device. Alternatively, an identifier may be selected by a user tapping a touch screen of the computing device at a location on the touch screen that displays the identifier.

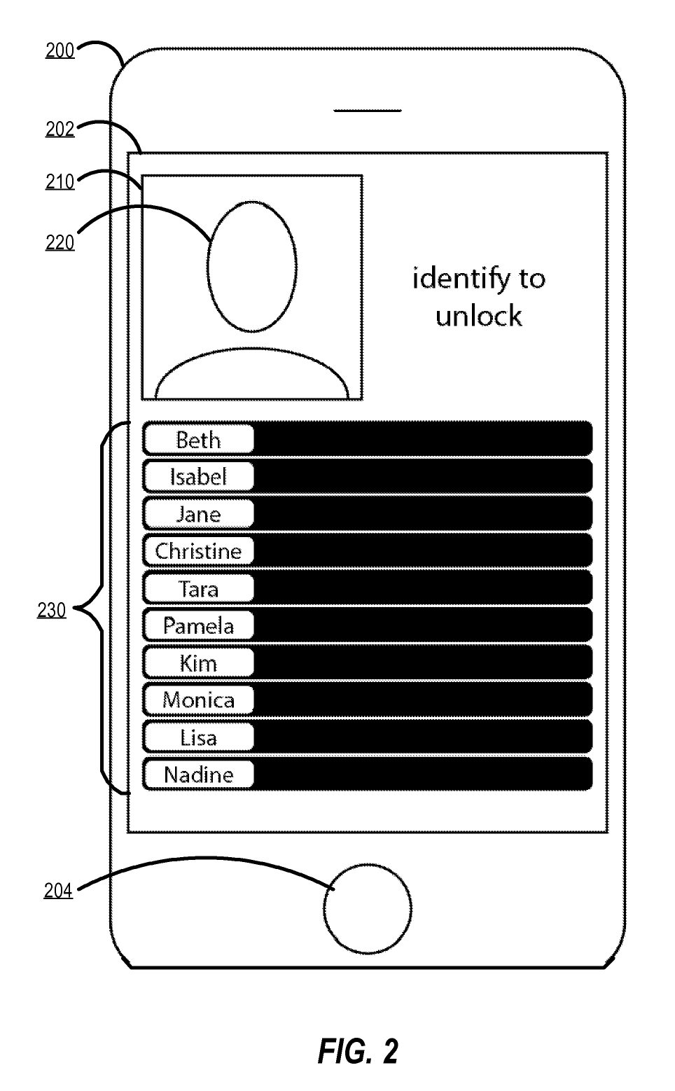

FIG. 2 is a block diagram that depicts a handheld device 200 that includes a touch screen display 202, according to an embodiment of the invention. Handheld device 200 also includes an activation button 204 that, when selected, turns on touch screen display 202 and, optionally, initiates an authentication process. Touch screen display 202 displays an image 210 that depicts an object 220. Image 210 may be displayed in response to user activation of button 204. Handheld device 200 may or may not have Internet connectivity at the time an authenticating process executing on device 200 selects image 220 to display. Touch screen display 202 also displays a set of ten names 230. User selection of any of the names in the set of names 230 acts as input to the authentication process. Because there are only ten names in the set, an unauthorized user has a 10% of gaining access to handheld device 200. To be considered “secure,” most authentication processes require a higher level of security, such as less than 1% chance of unauthorized access. Displaying a different set of ten names three times (i.e., as part of a 3-round process) in order to grant access means that a person guessing at random would have a 0.1% chance of gaining unauthorized access.

In an embodiment, a multiple round process may involve one round that requires one type of data and another round that requires another type of data. For example, one round of a multiple round process may involve image-based authentication (whether requiring the user to input each character of a name or to select an already-displayed name), while another round of the multiple round process may require a four-digit PIN, while another round of the multiple round process may require drawing a pattern. Thus, for a multiple round process, each round may involve a different type of data and/or a different type of question.

### SET OF IDENTIFIERS

As part of authenticating a user for a computing device, if the user selects the correct identifier for each round, then the user is likely to be either the owner of the computing device or a person within the same circle of friends of the user.

To prevent an unauthorized user from gaining access to a computing device, an authenticating process executing on the computing device should select a set of identifiers to display such that an unauthorized user cannot easily determine which identifiers in the set are unlikely to be the correct identifier. For example, if an object depicted in an image is the face of the authorized user's Caucasian grandmother, then the set of identifiers that are displayed as possible identifiers should not include male names, uncommon names, or certain ethnic names (e.g., Indian or Chinese names) that are very likely not possible names of the grandmother.

In an embodiment, the set of identifiers are the first and/or last initials instead of full names. For example, an identifier may be “D.L.” or “TL” for first and last initials. As another example, an identifier may simply be “H” or “K” for first initials. Providing initials instead of the entire first and/or last name, the impact of age, ethnicity, and gender as issues in selecting a proper set of identifiers is reduced.

Another situation in which an identifier can be easily discarded by an unauthorized user as a possible choice is after the user selects the correct identifier during a particular round (e.g., the first round). The set of identifiers displayed during a subsequent round should not include the previously-selected correct identifier as a “decoy,” during the subsequent round. For example, a computing device, as part of the first round of a multiple round process, displays a first image and ten names, including the name “Mary.” A user selects the name “Mary,” which is the correct choice for the first image. The computing device then displays, for the second round of the multiple round process, a second image that depicts Susan. The computing device displays another set of ten names. However, the authenticating process ensures that the other set of ten names excludes “Mary.” Therefore, if an authenticating process is a multiple round process, then the set of identifiers that the authenticating process selects to display as options during the second and any subsequent rounds does not include an identifier that was correctly chosen during a previous round.

In an embodiment, at least some of the identifiers that are displayed as part of the authentication process are selected from identifiers that are currently associated with images that are accessible to the authenticating process. In a related embodiment, at least some of the identifiers are selected from an “ID bank” or list that comes as part of the authentication software. In other words, at least some of the identifiers are “pre-defined.” Thus, some of the pre-defined identifiers might not identify any of the objects (e.g., persons) depicted in images that are accessible to the authenticating process.

### CONCURRENTLY DISPLAYING MULTIPLE OBJECTS

In an embodiment, multiple objects are depicted concurrently by a computing device as part of the authentication process. The multiple objects may be depicted in a single image or in multiple images. For example, a single image may be a picture of Adam, Brian, Carl, and Drew. As another example, multiple images are displayed concurrently, each of which depicts a different one of Elaine, Francine, Gail, and Helen.

In both examples, while the computing device concurrently displays depictions of multiple objects as part of the authentication process, the computing device displays a question that prompts a user of the computing device to properly identify the object with a given identifier. For example, while displaying images of Elaine, Francine, Gail, and Helen, the computing device displays the following question, “Which person is Gail?” The user must then select the depiction of Gail in order to be authenticated.

Concurrently displaying depictions of multiple objects may be part of a single round process or a multiple round process. Again, other rounds of a multiple round process may require other types of data, such as a four-digit PIN, a password, a typed (or spoken) name of an object depicted in a displayed image, or a selected name from a set of names that are displayed in association with a displayed image.

### NON-NAME IDENTIFICATION

As noted previously, instead of a name of an object, a user may be prompted to provide other types of information about an object depicted in an image. Non-limiting examples of such information include the year a person was born, the age of a man-made structure, where a person lives, a generic description of a relatively-unknown object, or a user-specified description that only the user of the computing device (or a limited number of people) might know. For example, as part of a multiple round authentication process, an authenticating process selects an image of the user's father and prompts the user to enter where the person was born. If the user enters the proper location (which is associated with the image), then the authenticating process selects an image of the user's sister and prompts the user to enter the person's birthday. If the user enters the proper birthday (which is associated with the image), then the user is granted access to the computing device.

As another example, as part of a single round authentication process, an authenticating process selects an image of the Eiffel Tower and prompts the user to enter a description of the Eiffel Tower that the user provided previously (e.g., using a different computing device), such as “The Big Stick.” While Eiffel Tower is a global icon, not many people have referred to it as “The Big Stick.” Therefore, an unauthorized person that accesses the computing device and sees the Eiffel Tower as part of the authentication process will most likely not know that “The Big Stick” is the answer.

A user may cause non-name identifiers to be associated with objects depicted in images prior to the authentication process. The establishment of an association between an identifier and an image or an object depicted in an image may or may not be performed in the context of establishing security settings. For example, a user may change the security settings of a computing device from PIN authentication to image-based authentication, as described herein. When the image-based authentication option is selected, the user may then be allowed to select which images are to be displayed as part of the authentication process and, optionally, provide, for each selected image, data to be associated with the selected image. Such data may be, for example, a name of a person depicted in the selected image, a description of an object depicted in the selected image, or a series of numbers and/or characters that only the user would know is associated with an object depicted in the selected image. For example, a user may select an image of the Golden Gate Bridge and then enter ‘5341’ as the authentication data, which will be associated with that image. Thus, ‘5341’ must be entered whenever that image is displayed as part of the authentication process. The association of the number ‘5341’ with the Golden Gate Bridge might only have relevance to the user because that is the suffix of a phone number of a memorable person the user met at the Golden Gate Bridge.

### IMAGE SELECTION CRITERIA

An authenticating process executing on a computing device uses one or more selection criteria to select an image to display as part of user authentication, whether the authenticating process is a single round process or a multiple round process. One example of a selection criterion is how long it has been since a particular image was last displayed by the computing device as part of user authentication. The amount of time that has elapsed since a particular image has been displayed as part of the authentication process is referred to herein as the “image time” of the particular image. The greater the image time associated with a particular image, the more likely the authenticating process will select the particular image to display. Conversely, the lower the image time associated with a particular image, the less likely the authenticating process will select the particular image to display.

In an embodiment, the set of images from which the authenticating process selects for displaying to a user are selected in a round-robin fashion. For example, the set of images consists of images A, B, C, D, and E. The authentication process first selects image A, then selects image B, and so forth. After selecting image E, the authentication process selects image A. Over time, additional images may be added to the set of images. For example, given the initial set of images A-E, images G, H, and I are later added to the set. If the most recently selected image is image C, then images G, H, and I are each selected for display before image D.

### IMAGE SELECTION CRITERIA: LOCATION

Another selection criterion may be location. For many digital pictures, the camera that “took” (or generated) a digital picture (image) stores location data that identifies the location at which the picture was taken. This location is associated with the digital picture. Also, a user may “manually” associate (e.g., using the camera or another device) a location with a digital image. The authenticating process may leverage such location data when selecting an image to display as part of user authentication. For example, during a first single round process, an authenticating process selects a first image that depicts a building in France to display. Later, during a second single round process, the authenticating process avoids selecting another image that is associated with France and, instead, selects a second image that depicts a natural formation in Australia to display.

Thus, an authenticating process may select an image based on whether a location associated with the image is the same as or near a location associated with a previously-displayed image. The amount of time that has elapsed since an image that is associated with a particular location was last displayed as part of user authentication is referred to herein as the “location time” of the image. Two images that are associated with a particular location may be associated with the same location time, even though one of the images has never been displayed as part of the authentication process (or has not been displayed for a longer period of time relative to the other image). Thus, after displaying a particular image that is associated with a particular location, the authenticating process (or another process) designates the current time as the location time of the particular image and the location time of one or more other images that were taken at the particular location.

The location associated with an image may be of any granularity, such as specific geographical coordinates, a zip code, a city, a state, a county, and/or a country. For example, if one of two images is displayed as part of an authentication process and both images are associated with the same city, then the location times of both images are both updated to reflect the current time. But if the two images are associated with different cities, then only the location time of the displayed image is updated with the current time, even though both images may be associated with the same state.

In a related embodiment, the location time of a non-displayed image is updated with the current time only if the location associated with a displayed image (i.e., as part of the authentication process) is within a particular distance of the location associated with the non-displayed image. For example, image A is associated with location A and image B is associated with location B. Image A is displayed as part of an authentication process. The location time of image A is updated to reflect the current time (or the time at which image A was displayed). The location time of image B is also updated to reflect the current time only if location B is within a particular distance (e.g., 10 miles) from location A.

### IMAGE SELECTION CRITERIA: OBJECT IDENTITY

Another selection criterion may be the identity of an object. An authenticating process may select an image based on whether the identity of an object depicted in the image is the same as the identity of an object depicted in a previously-displayed image. The amount of time that has elapsed since an image that depicts a particular object has been displayed as part of the authentication process is referred to herein as the “object time” of the image. Similar to location time, two images that depict a particular object (for which the identity or a description is known to the authenticating process) may be associated with the same object time, even though one of the images has never been displayed (or has not been displayed for a longer period of time relative to the other image) as part of the authentication process. Thus, after displaying a particular image that depicts a particular object, the authenticating process (or another process) designates the current time as the object time of the particular image and the object time of one or more other images that depict the same object.

In an embodiment where images are selected in a round-robin fashion, an image that is selected for display is not selected until every other available image that depicts another object is displayed. For example, images A-E each depict a different person's face and images A and F depicts the same person's face, then an order in which images A-F are selected may be as follows: A, B, C, D, E, F, B, C, D, E, A, etc. Therefore, images B-E will be displayed about twice as often as each of images A and F.

As indicated in this last example, multiple selection criteria (e.g., image time, location time, and object time) may be used together in the determination of which image to select and display as part of the authentication process.

The process of selecting images based on one or more selection criteria is applicable in both the single round process and the multiple round process. For example, a first image that is displayed during the first round of a multiple round process may be of a friend in California, a second image that is displayed during the second round of the multiple round process may be of a family member in New York, and the third image that is displayed during the third round of the multiple round process may be of a friend in France. Even someone in the user's circle of friends might not be able to know each of these three individuals.

Furthermore, in a multiple round process, the authenticating process may employ a different set of one or more selection criteria for each round. For example, the authentication process may rely on image time during a first round, location time during a second round, and object time during a third round.

### IMAGE SELECTION CRITERIA: AGE OF PERSON

Another selection criterion may be the age of a person that is depicted in an image. An authenticating process may select an image based on whether a person depicted in an image is older (or younger) than a certain age.

The age of a person depicted in an image may have been established previously based on user input, e.g., from the owner. The user input may have been provided at a different device than the computing device that executes the authenticating process. Alternatively, the age of a person depicted in an image may be determined automatically, for example, by a facial detection/recognition process that is configured to determine an approximate age of a person based on facial features (and/or other characteristics) reflected in an image of that person. Such an age “approximator” may have executed on a device that is separate from the computing device for whose access is sought.

The amount of time that has elapsed since an image that depicts a person with a certain age (or within a certain age range) has been displayed as part of the authentication process is referred to herein as the “age time” of the image. Similar to location time, two images that depict different persons with the same age (or are in the same age range or age “category”, such as “40s” or “50s”) may be associated with the same age time, even though one of the images has never been displayed (or has not been displayed for a longer period of time relative to the other image) as part of the authentication process. Thus, after displaying a particular image that depicts a particular person, the authenticating process (or another process) designates the current time as the age time of the particular image and the age time of one or more other images that depict other persons of the same or similar age.

Thus, the authenticating process may leverage age information when selecting an image to display as part of user authentication. For example, during a first round of a multi-round process, an authenticating process selects a first image that depicts the face of a 28 year-old person to display. Later, during a second round of the multi-round process, the authenticating process avoids selecting another image that depicts a person younger than 50 years old (or between 18 and 40 years of age) and, instead, selects a second image that depicts a person who is over 50 years old to display.

### LOCKED STATE VERSUS UNLOCKED STATE

A computing device is said to be in a “locked state” if a user does not have access to the computing device and the user must enter certain input to access the computing device. Conversely, a computing device is in an “unlocked state” if a user has access to the computing device. For example, the computing device may be a smart phone that includes one or more physical buttons and a touch screen. While in a locked state, a user selects one of the physical buttons, which selection causes an image to be displayed on the touch screen. In order for the computing device to switch to the “unlocked state,” the user must provide the proper input, typically via the touch screen, although voice input via a microphone on the smart phone is also possible.

The time period between a computing device's change from a locked state to an unlocked state and back to the locked state again is referred to herein as a “user session.” Thus, a user has access to the computing device during a user session. In an embodiment, from one user session to a subsequent user session, the input that is required to change a computing device from the locked state to the unlocked state may change. For example, consider user sessions U1, U2, and U3. The input required to cause the computing device to enter U1 is referred to as first data. The input required to cause the computing device to enter U2 is referred to as second data. The input required to cause the computing device to enter U3 is referred to as third data. The second data may be different than the first and third data and the third data may be different than the first data. This change in required input is made without a user, during U1, U2, or U3, changing the lock settings on the computing device. For example, some computing devices allow a user to change the lock settings, for example, from (a) requiring a user to enter one password to unlock the computing device to (b) requiring a user to enter a different password to unlock the computing device. However, in this embodiment, the lock settings on the computing device are not modified by a user during any of U1, U2, or U3.

In the examples above, the type of authentication used to manage access to a computing device is image-based authentication. Thus, the input required to “unlock” a computing device is a name, a description, or other data associated with an object that is depicted in an image. However, in an embodiment, the input required to unlock the computing device may be other types of input, such as entering a PIN, entering a password, or drawing a pattern.

In an embodiment, a computing device employs multiple types of authentication without a user of the computing device providing any input that explicitly changes the type of authentication. Thus, for example, given user sessions U1, U2, and U3 referred to above, the third data may be of a type (e.g., PIN) that is different than the type of the second data (e.g., pattern) and the type of the first data (e.g., name of object).

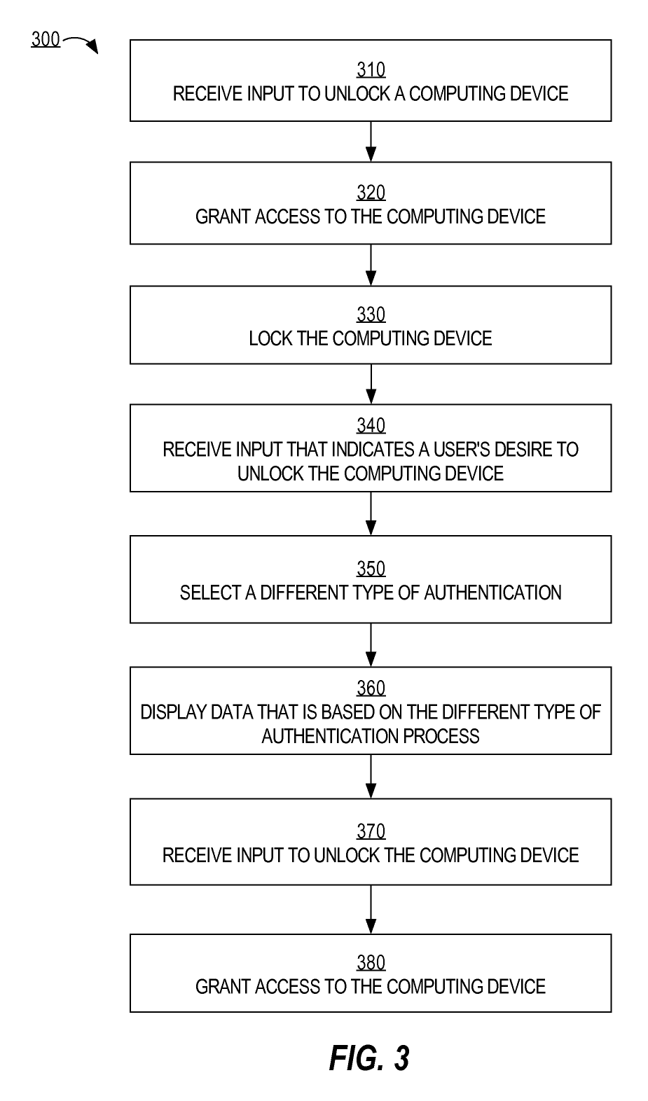

FIG. 3 is a flow diagram that depicts a process 300 for using different types of authentication, according to an embodiment of the invention. In step 310, an authenticating process executing on a computing device receives input to unlock the computing device.

In step 320, if the input is correct, then the authenticating process grants a user access to the computing device.

In step 330, the authenticating process (or another process) locks the computing device. A computing device may automatically lock itself after a certain period of inactivity, such as 30 seconds. During the user session between steps 320 and 330, the user does not change the security or lock settings of the computing device. Thus, the user does not select any type of authentication during the user session.

In step 340, the computing device receives input that indicates a user's desire to unlock the computing device. Such input may be pushing an activation button on the computing device.

In step 350, the authenticating process selects a type of authentication from among a multiple types of authentication. The authenticating process may select a type of authentication that is different than a previous type of authentication. In fact, one selection criterion for selecting a type of authentication may be selecting an authentication process that is of a different type than the authentication process that was most recently used to authenticate a user. For example, if the authentication process used to authenticate a user for the prior user session (i.e., between steps 320 and 330) involved entering a 4-digit PIN, then the authenticating process might select a multiple round image-based authentication process.

In step 360, the authenticating process displays data based on the selected type of authentication process. For example, if the type of authentication selected in step 350 is a single round authentication process, then the authenticating process selects an image to display.

In step 370, the authenticating process receives input to unlock the computing device. The input is compared to authentication data that is required to unlock the computing device.

In step 380, the authenticating process grants access to the computing device if the input matches the required authentication data. For example, if the computing device displays, in step 360, an image that depicts a person whose name is David, the authentication data associated with the image is ‘David’, and the input received in step 370 is ‘David’, then the authenticating process unlocks the computing device.

### HARDWARE OVERVIEW

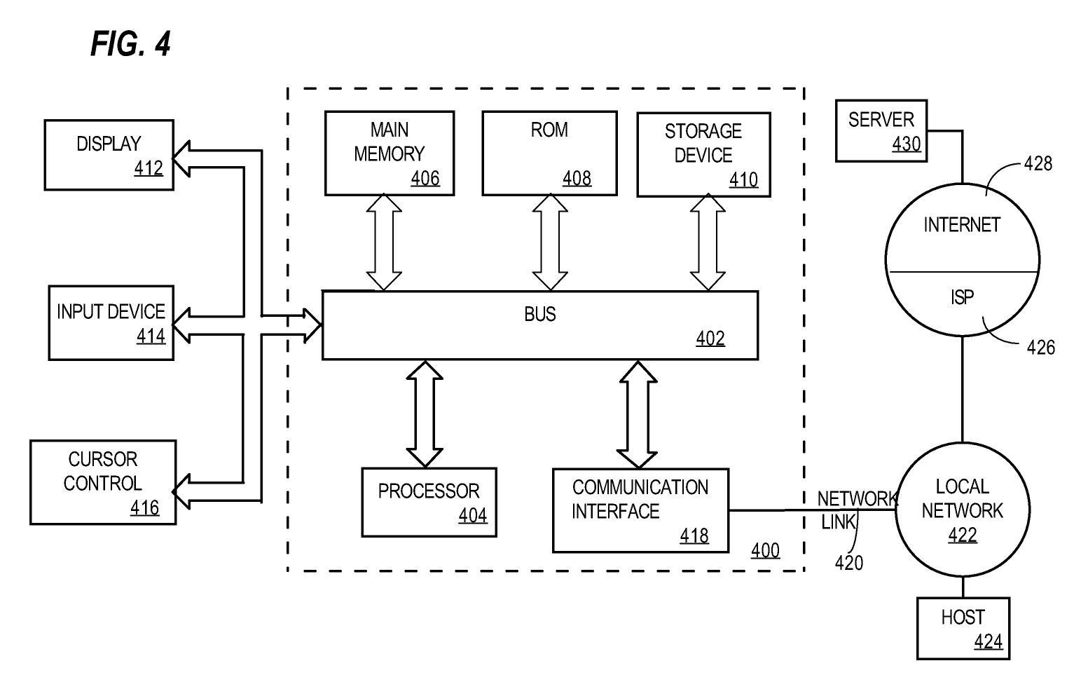

With reference to FIG. 4, there is shown a block diagram of a sample device 400 in which one embodiment of the present invention may be implemented. As shown, device 400 includes a bus 402 for facilitating information exchange, and one or more processors 404 coupled to bus 402 for executing instructions and processing information. Device 400 also includes one or more storages 406 (also referred to herein as computer readable storage media) coupled to the bus 402. Storage(s) 406 may be used to store executable programs, permanent data (e.g. captured images, metadata associated with the captured images, etc.), temporary data that is generated during program execution (e.g. pre-captured images, etc.), and any other information needed to carry out computer processing.

Storage(s) 406 may include any and all types of storages that may be used to carry out computer processing. For example, storage(s) 406 may include main memory (e.g. random access memory (RAM) or other dynamic storage device), cache memory, read only memory (ROM), permanent storage (e.g. one or more magnetic disks or optical disks, flash storage, etc.), as well as other types of storage. The various storages 406 may be volatile or non-volatile. Common forms of computer readable storage media include, for example, a floppy disk, a flexible disk, hard disk, magnetic tape, or any other magnetic medium, a CD-ROM, DVD, or any other optical storage medium, punchcards, papertape, or any other physical medium with patterns of holes, a RAM, a PROM, an EPROM, a FLASH-EPROM or any other type of flash memory, any memory chip or cartridge, and any other storage medium from which a computer can read.

As shown in FIG. 4, storage(s) 406 store at least several sets of executable instructions, including an operating system 414 and one or more applications 412. The processor(s) 402 execute the operating system 414 to provide a platform on which other sets of software may operate, and execute one or more of the applications 412 to provide additional, specific functionality. For purposes of the present invention, the applications 412 may include, for example, an image capture application, an image review application, as well as other applications. In one embodiment, the applications 412 and operating system 414 cooperate to implement the techniques described herein. That is, portions of the techniques may be performed by the applications 412 and portions may be performed by the operating system 414. It should be noted though that this is just one possible embodiment. As an alternative, all of the techniques may be performed by the operating system 414. As a further alternative, all of the techniques may be performed by one or more of the applications 412. All such possible implementations are within the scope of the present invention.

The device 400 further includes one or more user interface components 408 coupled to the bus 402. These components 408 enable the device 400 to receive input from and provide output to a user. On the input side, the user interface components 408 may include, for example, a keyboard/keypad having alphanumeric keys, a cursor control device (e.g. mouse, trackball, touchpad, etc.), a touch sensitive screen capable of receiving user input, a microphone for receiving audio input, etc. On the output side, the components 408 may include a graphical interface (e.g. a graphics card) and an audio interface (e.g. sound card) for providing visual and audio content. The user interface components 408 may further include a display 416 (in one embodiment, the display 416 is a touch sensitive display) for presenting visual content, and an audio device 418 (e.g. one or more speakers) for presenting audio content. In one embodiment, the operating system 414 and the one or more applications 412 executed by the processor(s) 404 may provide a software user interface that takes advantage of and interacts with the user interface components 408 to receive input from and provide output to a user. This software user interface may, for example, provide menus that the user can navigate using one of the user input devices mentioned above, soft buttons that can be invoked via touch, a soft keyboard, etc. This software interface may also interact with the touch sensitive display 46 to receive information indicating which location(s) of the display 46 is being touched by the user and to translate this information into input that the operating system 414 and the application(s) 412 can use (e.g. to determine which portion(s) of a displayed image is being touched, which menu item or button is being invoked, etc.). These and other functions may be performed by the software user interface provided by the operating system 414 and the application(s) 412.

In one embodiment, the user interface components 408 further include one or more image capturing mechanisms 420. For purposes of the present invention, image capturing mechanism 420 may be any mechanism capable of capturing a visual image. In one embodiment, image capturing mechanism 420 takes the form of a digital camera having one or more lenses and an array of optical sensors for sensing light directed by the one or more lenses. The array of optical sensors (where each optical sensor represents a pixel) provides output signals indicative of the light sensed. The output signals from the array of optical sensors can be used to derive a captured image. For purposes of the present invention, the lens(es) of the image capturing mechanism 420 may be static or mechanically movable to implement an optical zoom.

In addition to the components set forth above, the device 400 may further include one or more communication interfaces 410 coupled to the bus 402. These interfaces 410 enable the device 400 to communicate with other components. The communication interfaces 410 may include, for example, a network interface (wired or wireless) for enabling the device 400 to send messages to and receive messages from a local network. The communications interfaces 410 may also include a 3G interface for enabling the device to access the Internet without using a local network. The communication interfaces 410 may further include a telephone network interface for enabling the device 400 to conduct telephone communications. The communication interfaces 410 may further include a wireless interface (e.g. Bluetooth) for communicating wirelessly with nearby devices, such as wireless headsets, earpieces, etc. The communication interfaces 410 may further include a jack for interfacing with a set of wired headphones, headsets, earphones, etc. These and other interfaces may be included in the device 400.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
causing an image, that is stored on a computing device, to be displayed by the computing device, wherein the image depicts one or more objects;
after the image is displayed, receiving input from a user at the computing device;
in response to receiving the input, determining, at the computing device, whether the input matches authentication data associated with the image; and
in response to determining that the input matches the authentication data associated with the image, allowing the user to access the computing device;
wherein the method is performed by the computing device.

2. The method of claim 1, wherein at least one of the one or more objects includes a person's face.

3. The method of claim 1, wherein:
prior to causing the image to be displayed, the authentication data was associated with the image by a second computing device that is separate than the computing device.

4. The method of claim 1, further comprising, prior to causing the image to be displayed:
selecting the image from a plurality of images that are stored on the computing device;
wherein the image is selected from the plurality of images based on when each image of the plurality of images was last displayed by the computing device.

5. The method of claim 1, further comprising, prior to causing the image to be displayed:
selecting the image from a plurality of images that are stored on the computing device;
wherein the image is selected from the plurality of images based on when an image that depicts one of the one or more of the objects was last displayed by the computing device as part of an authentication process.

6. The method of claim 1, wherein the steps of causing, receiving, determining, and allowing are performed while the computing device does not have a connection to any network.

7. The method of claim 1, wherein the computing device is a handheld device that is one of a tablet computer, a laptop computer, or a cell phone.

8. A method comprising:
before granting access to a computing device:
causing a first image, that is stored on the computing device, to be displayed by the computing device;
after the first image is displayed, receiving first input from a user at the computing device;
in response to receiving the first input, determining, at the computing device, whether the first input matches first authentication data that is associated with a first object that is depicted in the first image;
in response to determining that the first input matches the first authentication data, displaying a second image;
after displaying the second image, receiving second input from the user at the computing device;
in response to receiving the second input, determining, at the computing device, whether the second input matches second authentication data that is associated with a second object that is depicted in the second image; and
in response to determining that the second input matches the second authentication data, allowing the user to access the computing device;
wherein the method is performed by the computing device.

9. The method of claim 8, wherein the first object is a face of a first person and the second object is a face of a second person that is different than the first person.

10. The method of claim 8, wherein:
causing the first image to be displayed comprises displaying a plurality of names;
the first input comprises a selection of a name from the plurality of names.

11. The method of claim 8, further comprising, prior to causing the first image to be displayed:
selecting the first image from a plurality of images that are stored on the computing device;
wherein the first image is selected from the plurality of images based on when each image of the plurality of images was last displayed by the computing device.

12. The method of claim 8, further comprising, prior to causing the first image to be displayed:
selecting the first image from a plurality of images that are stored on the computing device;
wherein the first image is selected from the plurality of images based on when an image that depicts an object that is also depicted in one or more images of the plurality of images was last displayed by the computing device.

13. The method of claim 8, further comprising, prior to causing the first image to be displayed:
selecting the first image from a plurality of images that are stored on the computing device;
wherein the first image is selected from the plurality of images based on when an image that is associated with a location that is also associated with one or more images of the plurality of images was last displayed by the computing device.

14. A method comprising:
while a handheld device is in a locked state during a first period of time:
preventing a user from accessing the handheld device,
receiving first input at the handheld device, and
in response to receiving the first input, determining, at the handheld device, based on the first input, whether to grant access to the handheld device;
in response to determining to grant access to the handheld device, causing the handheld device to be in an unlocked state;
while the handheld device is in the unlocked state, allowing the user to access the handheld device;
wherein, while the handheld device is in the unlocked state, no input that changes any security settings on the handheld device is received from the user;
after causing the handheld device to be in the unlocked state, causing the handheld device to be in the locked state;
while the handheld device is in the locked state during a second period of time that is after the first period of time and does not overlap the first period of time:
preventing the user from accessing the handheld device,
receiving, at the handheld device, second input that is different than the first input, and
in response to receiving the second input, determining, at the handheld device, based on the second input, whether to grant access to the handheld device;
in response to determining to grant access to the handheld device, causing the handheld device to be in the unlocked state;
wherein the method is performed by the handheld device.

15. The method of claim 14, further comprising:
prior to receiving the first input, displaying a first image that depicts a first object; and
prior to receiving the second input, displaying a second image that depicts a second object that is different than the first object.

16. The method of claim 15, wherein:
the first object is a face of a first person and the first data is a name of the first person; and
the second object is a face of a second person that is different than the first person and the second data is a name of the second person.

17. The method of claim 14, wherein the type of authentication that is used to authenticate the user during the first period of time is different than the type of authentication that is used to authenticate the user during the second period of time.

18. The method of claim 17, wherein:
the type of authentication that is used to authenticate the user during the first period of time is one of image-based authentication, password-based authentication, pattern-based authentication, or PIN-based authentication.

19. One or more storage media storing instructions which, when executed by one or more processors, cause performance of the method recited in claim 1.

20. One or more storage media storing instructions which, when executed by one or more processors, cause performance of the method recited in claim 2.

21. One or more storage media storing instructions which, when executed by one or more processors, cause performance of the method recited in claim 3.

22. One or more storage media storing instructions which, when executed by one or more processors, cause performance of the method recited in claim 4.

23. One or more storage media storing instructions which, when executed by one or more processors, cause performance of the method recited in claim 5.

24. One or more storage media storing instructions which, when executed by one or more processors, cause performance of the method recited in claim 6.

25. One or more storage media storing instructions which, when executed by one or more processors, cause performance of the method recited in claim 7.

26. One or more storage media storing instructions which, when executed by one or more processors, cause performance of the method recited in claim 8.

27. One or more storage media storing instructions which, when executed by one or more processors, cause performance of the method recited in claim 9.

28. One or more storage media storing instructions which, when executed by one or more processors, cause performance of the method recited in claim 10.

29. One or more storage media storing instructions which, when executed by one or more processors, cause performance of the method recited in claim 11.

30. One or more storage media storing instructions which, when executed by one or more processors, cause performance of the method recited in claim 12.

31. One or more storage media storing instructions which, when executed by one or more processors, cause performance of the method recited in claim 13.

32. One or more storage media storing instructions which, when executed by one or more processors, cause performance of the method recited in claim 14.

33. One or more storage media storing instructions which, when executed by one or more processors, cause performance of the method recited in claim 15.

34. One or more storage media storing instructions which, when executed by one or more processors, cause performance of the method recited in claim 16.

35. One or more storage media storing instructions which, when executed by one or more processors, cause performance of the method recited in claim 17.

36. One or more storage media storing instructions which, when executed by one or more processors, cause performance of the method recited in claim 18.
